(19) United States
(12) Patent Application Publication
(10) Pub. No.: US 2016/0125046 A1
(43) Pub. Date: May 5, 2016

(54) INFORMATION PROCESSING DEVICE, INFORMATION PROCESSING METHOD, AND STORAGE MEDIUM

(71) Applicant: NEC Corporation, Minato-ku, Tokyo (JP)

(72) Inventor: Naomi YANO, Tokyo (JP)

(21) Appl. No.: 14/893,288

(22) PCT Filed: Dec. 25, 2013
(86) PCT No.: PCT/JP2013/084620

§ 371 Date: Nov. 23, 2015

(30) Foreign Application Priority Data
Jun. 12, 2013 (JP) 2013-123317

(51) Int. Cl. G06F 17/30

(52) U.S. Cl. CPC G06F 17/30554; G06F 17/3028; G06F 17/3025; G06F 17/30528

(57) ABSTRACT

This information processing device has: a question presentation unit which obtains at least one piece of question information from a question information storage means, in which pieces of question information are stored, and presents the piece of information; an answer reception unit which receives an answer to the presented question information; and a suitability calculation unit which converts the received answer into a first index value, which indicates the suitability of a coloration scheme to the answer, and calculates the suitability of each of a plurality of prepared coloration schemes on the basis of the first index value.

### TECHNICAL FIELD

The present invention relates to an information processing device, an information processing method, and a program that recommend a suitable coloration scheme.

### BACKGROUND ART

In order to design a screen coloration scheme that is suitable for a system, it is desirable to select a coloration scheme that meets all of various aspects such as; meeting accessibility standards for reliable legibility of information, providing a beautiful combination of colors that work together well to minimize eye strain even when watching the screen for a long time, and being suitable for the image of the system and users. However, selecting the coloration scheme that meets a various aspects is difficult for a person who does not have a special knowledge of the coloration scheme.

Approaches for helping users in choosing a right coloration scheme are disclosed in PTL 1 to PTL 4 given below. PTL 1 discloses an approach that prepares many coloration scheme proposals beforehand, allows a customer to select a color image in the customer's mind by using questions that are understandable also to non-professionals, and presents the coloration scheme that matches answers to the questions by displaying an image. PTL 2 discloses an approach that recommends the coloration scheme according to an image word from among multiple coloration schemes prepared beforehand. PTL 3 discloses an approach that extracts color information from input data (a document), calculates the degrees of suitability of coloration schemes in order to determine a color rule that is closest to a color rule in the input data from among a plurality of coloration scheme rules prepared beforehand, and recommends the coloration scheme that matches an image in user's mind. PTL 4 discloses an approach that evaluates a readability of text on a Web page and recommends the coloration scheme by taking the readability of the Web page into account.

### CITATION LIST

### Patent Literature

PTL 1: Japanese Patent Publication No. 3067746

PTL 2: Japanese Patent Application Laid-open Publication No. 2002-169855

PTL 3: Japanese Patent Publication No. 4337878

PTL 4: Japanese Patent Application Laid-open Publication No. 2002-197403

### SUMMARY OF INVENTION

### Technical Problem

It is difficult to determine, however, by using any of the approaches in Patent Literatures given above as to how much the recommended coloration scheme suits to an object to be colored. In particular, with the approaches in PTL 1 and PTL 2, it is difficult to determine as to how much each coloration scheme suits to an object to be colored when a plurality of coloration schemes are recommended.

An object of the present invention is to provide an information processing device, an information processing method, and a program that enable to readily determine as to how much the recommended coloration scheme suits to an object to be colored.

### Solution to Problem

According to the present invention, an information processing is provided. The information processing device includes question presenting means for acquiring at least one piece of question information from question storage means in which pieces of the question information are stored and presenting the piece of question information, answer receiving means for receiving an answer to the presented question information. The information processing device includes suitability calculating means for converting the received answer into a first index value which indicates a degree of suitability of a coloration scheme to the answer and calculating a degree of suitability of each of a plurality of prepared coloration schemes on the basis of the first index value.

According to the present invention, an information processing method is provided. The information processing method is performed by a computer, acquiring at least one piece of question information from question storage means in which pieces of the question information are stored and presenting the piece of question information, receiving an answer to the presented question information; and converting the received answer into a first index value which indicates a degree of suitability of a coloration scheme to the answer and calculating a degree of suitability of each of a plurality of prepared coloration schemes on the basis of the first index value.

According to the present invention, a program is provided. The program causes a computer to function as: question presenting means for acquiring at least one piece of question information from question storage means in which pieces of the question information are stored and presenting the piece of question information, answer receiving means for receiving an answer to the presented question information, and suitability calculating means for converting the received answer into a first index value which indicates a degree of suitability of a coloration scheme to the answer and calculating a degree of suitability of each of a plurality of prepared coloration schemes on the basis of the first index value.

### Advantageous Effects of Invention

According to the present invention, it is possible to readily determine as to how much the coloration scheme recommended by an information processing device suits to an object to be colored.

### BRIEF DESCRIPTION OF DRAWINGS

The objects described above and other objects, features, and advantages will be more apparent from the following description of applicable exemplary embodiments and the accompanying drawings.

FIG. 1 is a block diagram illustrating an exemplary processing configuration of an information processing device according to a first exemplary embodiment.

FIG. 2 is a diagram illustrating an example of information stored in a question information storage unit according to the first exemplary embodiment.

FIG. 3 is a diagram illustrating an example of information stored in a coloration scheme storage unit according to the first exemplary embodiment.

FIG. 4 is a diagram illustrating another example of information stored in the coloration scheme storage unit according to the first exemplary embodiment.

FIG. 5 is a diagram illustrating components of a standard screen image.

FIG. 6 is a flowchart illustrating a process flow in an information processing device according to the first exemplary embodiment.

FIG. 7 is a diagram illustrating an example of a result output from the information processing device according to the first exemplary embodiment.

FIG. 8 is a block diagram illustrating an exemplary processing configuration of an information processing device according to a second exemplary embodiment.

FIG. 9 is a diagram illustrating an example of information stored in a question storage unit according to the second exemplary embodiment.

FIG. 10 is a diagram illustrating an example of a coloration scheme map.

FIG. 11 is a diagram illustrating an example of information stored in a coloration scheme storage unit according to the second exemplary embodiment.

FIG. 12 is a flowchart illustrating an example of a process flow in the information processing device according to the second exemplary embodiment.

FIG. 13 is a diagram illustrating an example of a result output from the information processing device according to the second exemplary embodiment.

FIG. 14 is a diagram illustrating an example of information stored in a question storage unit according to a third exemplary embodiment.

FIG. 15 is a flowchart illustrating a process flow in an information processing device according to the third exemplary embodiment.

FIG. 16 is a diagram illustrating an example of a result output from the information processing device according to the third exemplary embodiment.

FIG. 17 is a block diagram illustrating an exemplary processing configuration of a suitability calculating unit according to a fourth exemplary embodiment.

FIG. 18 is a diagram illustrating an example of information stored in a question storage unit according to the fourth exemplary embodiment.

FIG. 19 is a flowchart illustrating a process flow in the information processing device according to the fourth exemplary embodiment.

FIG. 20 is a diagram illustrating an example of a result output from the information processing device according to the fourth exemplary embodiment.

### DESCRIPTION OF EXEMPLARY EMBODIMENTS

Exemplary embodiments of the present invention will be described below with reference to the drawings. Throughout all of the drawings, like reference numerals are given to like components and description of the components will be omitted as appropriate.

### First Exemplary Embodiment

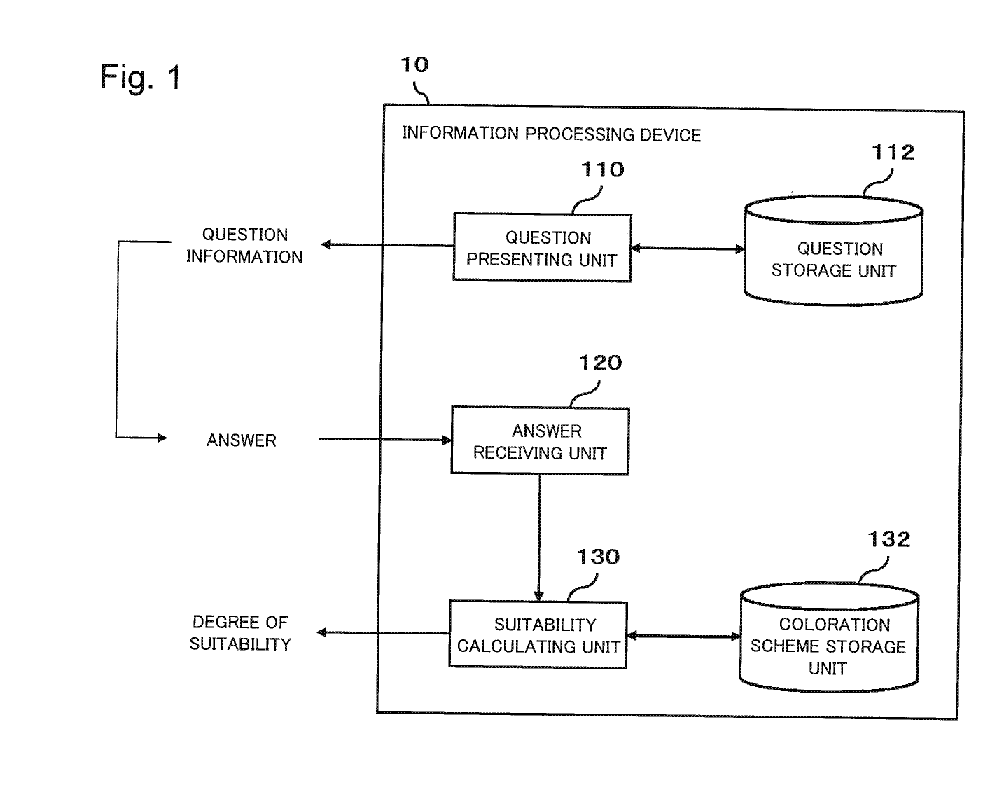

FIG. 1 is a block diagram illustrating an exemplary processing configuration of an information processing device 10 according to a first exemplary embodiment. In this exemplary embodiment, the information processing device 10 includes a question presenting unit 110, an answer receiving unit 120, and a suitability calculating unit 130. The information processing device 10 in FIG. 1 also includes a question storage unit 112 and a coloration scheme storage unit 132.

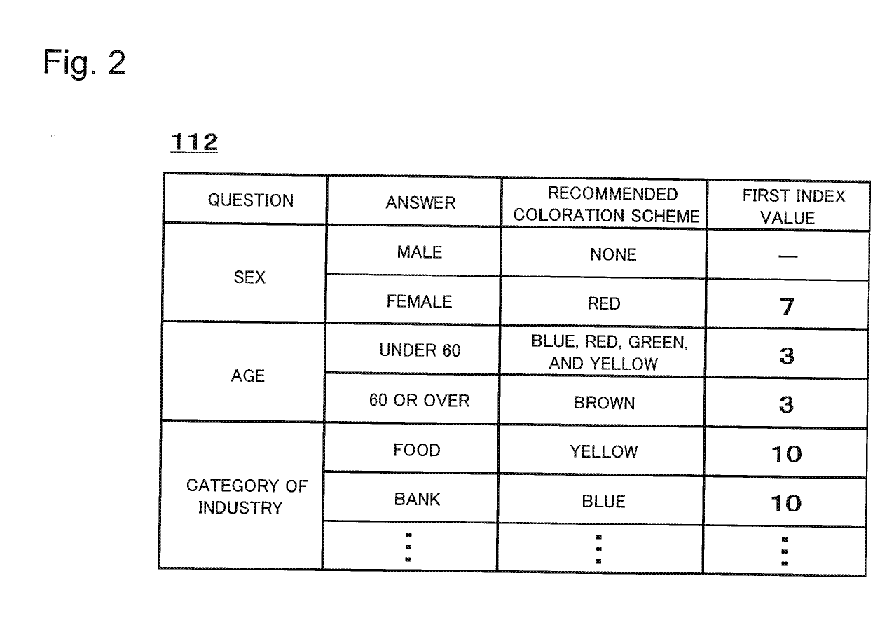

The question storage unit 112 stores at least one piece of question information. FIG. 2 illustrates an example of information stored in the question storage unit 112. In FIG. 2, the question information stored in the question storage unit 112 includes “question”, “answer”, “recommended coloration scheme”, and “first index value” columns. Questions for acquiring various kinds of information about systems, users, and businesses are stored in the “question” column. Multiple answers corresponding to the questions are stored in the “answer” column. Information indicating the coloration schemes suitable for the answers is stored in the “recommended coloration scheme” column. Information indicating degree of suitability for each coloration scheme stored in the “recommended coloration scheme” column to the corresponding answer is stored in the “first index value” column.

Note that the information in FIG. 2 is illustrative only and the question information stored in the question storage unit 112 is not limitative. The question storage unit 112 may store combinations of “question”, “answer”, “recommended coloration scheme”, and “score” other than the items of information given in FIG. 2. Further, the question storage unit 112 may store items of information other than “question”, “answer”, “recommended coloration scheme”, and “score”. When there is a plurality of coloration schemes that correspond to a given answer, the same first index value is associated with all of those coloration schemes in FIG. 2. Not limited to the above, however, different first index value may be associated with each of coloration schemes. Further, when there are a plurality of coloration schemes that correspond to a given answer, the same first index value may be associated with some of the plurality of coloration schemes. Accordingly, different first index values may be associated with the other coloration schemes.

Question information stored in the question storage unit 112 may be simple enough so that everyone can answer. For example, the question information may be simple questions as illustrated in FIG. 2 to which users can readily answer even without coloration scheme expertise. This allows a user who lacks coloration scheme expertise to readily select answers that lead to an optimum coloration scheme.

While the information processing device 10 includes the question storage unit 112 in FIG. 1, a device other than the information processing device 10 may include the question storage unit 112.

The question presenting unit 110 acquires at least one piece of question information from the question storage unit 112. The question presenting unit 110 then presents the acquired question information on a user terminal such as a PC (personal computer) used by a user. The question presenting unit 110 in this exemplary embodiment acquires and presents a “question” and a plurality of “answers” to the question from the question storage unit 112. The question presenting unit 110 may display the plurality of acquired “answers” in multiple-choice form. This improves usability. Note that presentation of questions is not limitative; the question presenting unit 110 may present, to a user, an input form or the like for acquiring answers to questions along with the questions.

Note that the question presenting unit 110 may acquire and present all of the items of question information stored in the question storage unit 112. Alternatively, the question presenting unit 110 may select and present some of the items of question information stored in the question storage unit 112. For example, priorities may be assigned to the items of question information stored in the question storage unit 112 and the question presenting unit 110 may acquire and present a predetermined number of items of question information in order of priority. Alternatively, the question presenting unit 110 may select and present a predetermined number of items of question information at random from the plurality of items of question information stored in the question storage unit 112.

The answer receiving unit 120 receives, from the user terminal, answers to question information presented by the question presenting unit 110. Specifically, the answer receiving unit 120 communicates with the user terminal via a cable or wirelessly to receive answers input on the user terminal. The answer receiving unit 120 then associates the received answers with the question information corresponding to the answers and sends the answers and the question information to the suitability calculating unit 130.

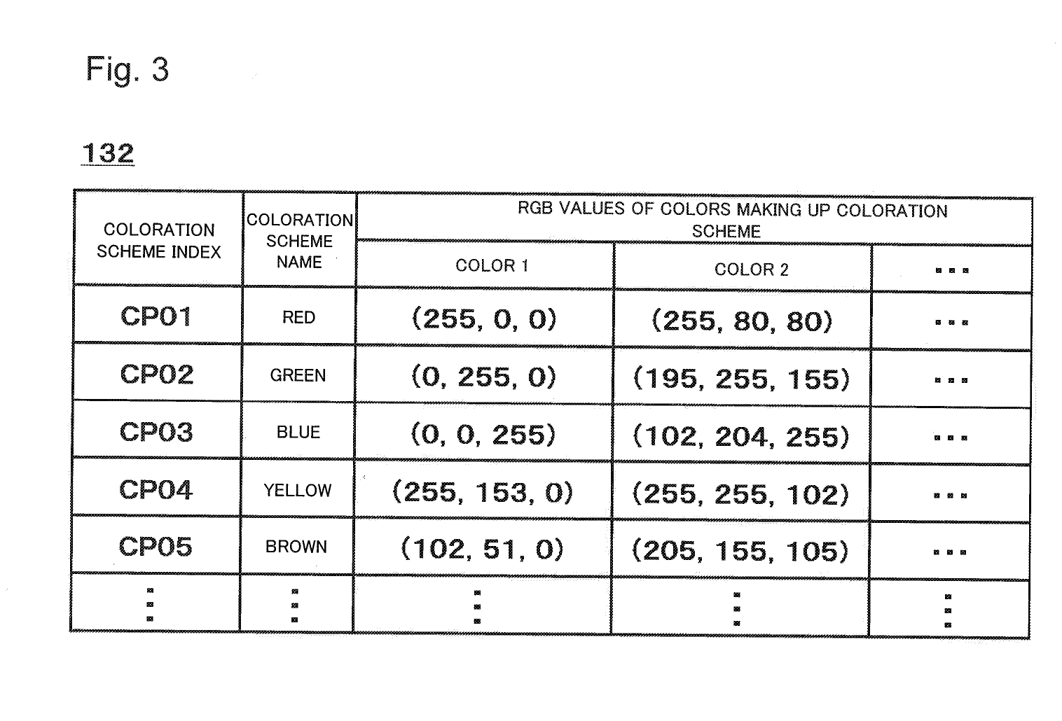

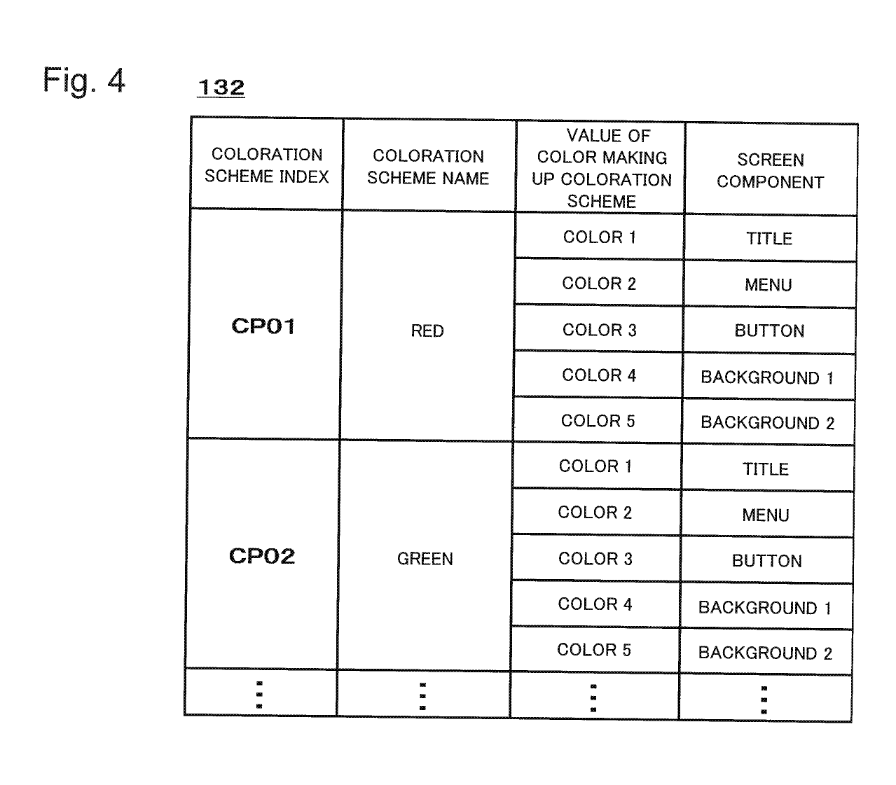

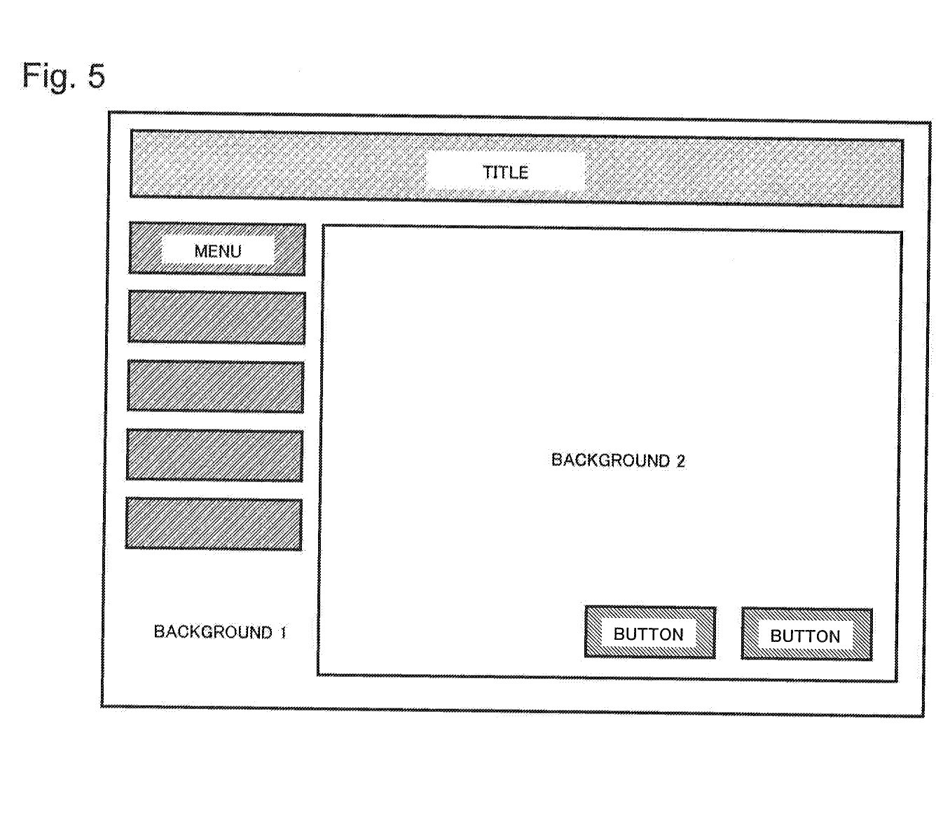

The coloration scheme storage unit 132 stores information about a plurality of coloration schemes prepared beforehand. FIG. 3 illustrates an example of information stored in the coloration scheme storage unit 132 in the first exemplary embodiment. In FIG. 3, the coloration scheme storage unit 132 stores indices of coloration schemes, coloration scheme names, and RGB values of M colors (colors 1 to M) that make up each coloration scheme in association with each other. However, the information stored in the coloration scheme storage unit 132 is illustrative only and is not limitative. FIG. 4 illustrates another example of information stored in the coloration scheme storage unit 132 in the first exemplary embodiment. For example, as illustrated in FIG. 4, the coloration scheme storage unit 132 may hold components of a standard screen image as illustrated in FIG. 5 and colors 1 to M that make up each coloration scheme in association with each other. The representation of color values in coloration schemes is not limited to RGB values. For example, other information that can identify colors, such as YCrCb values, may be used instead for representing the color values in the coloration schemes.

While the information processing device 10 includes the coloration scheme storage unit 132 in FIG. 1, a device other than the information processing device 10 may include the coloration scheme storage unit 132.

The suitability calculating unit 130 calculates degree of suitability for each of a plurality of prepared coloration schemes in accordance with answers received by the answer receiving unit 120. Specifically, the suitability calculating unit 130 converts the answer received by the answer receiving unit 120 into a first index value. In this exemplary embodiment, the suitability calculating unit 130 uses a combination of a question and an answer received by the answer receiving unit 120 to refer to the question storage unit 112. The suitability calculating unit 130 then retrieves a first index value corresponding to the selected answer. Further, the suitability calculating unit 130 calculates the degree of suitability for each coloration scheme on the basis of the retrieved first index value. In this way, the suitability calculating unit 130 converts answers acquired for the question information presented by the question presenting unit 110 into first index values. The suitability calculating unit 130 then adds together the first index values converted from each of the answers to calculate the degree of suitability for each coloration scheme.

When an input form or the like for acquiring answers to questions is presented by the question presenting unit 110, the answers are manually input by a user. In this case, the suitability calculating unit 130 uses, for example, morphological analysis to extract keywords from the manually input information. The suitability calculating unit 130 then retrieves first index values from received answers by searching for answers that most matches the extracted keywords from among the answers stored in the question storage unit 112 for the presented questions.

Note that the components of the information processing device 10 illustrated in FIG. 1 are not configuration of hardware units but are blocks of functional units. The components of the information processing device 10 is implemented by any combination of a hardware and a software, mainly including; a CPU and a memory of any computer, a program loaded in the memory to implement the components in FIG. 1, storage media such as a hard disc which stores the program, and an interface for connecting to a network. There are a wide variety of variations of methods and devices for implementing the combination.

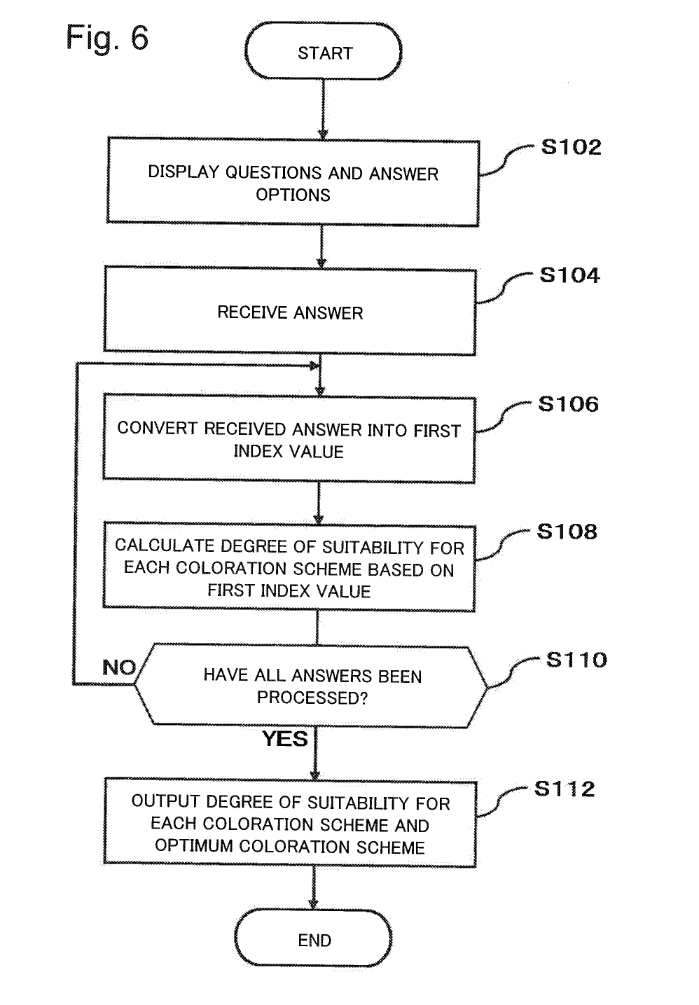

A process flow in the information processing device 10 according to the first exemplary embodiment will be described with reference to FIG. 6. FIG. 6 is a flowchart illustrating a process flow in the information processing device 10 according to the first exemplary embodiment.

The information processing device 10 acquires one or more questions and answers to the questions from the question storage unit 112. The information processing device 10 then displays the questions and a selection of the answers to the questions on a user terminal (S102). Assume, for example, that information illustrated in FIG. 2 is stored in the question storage unit 112. In this case, the information processing device 10 acquires three questions, “sex”, “age”, and “category of industry”, and answers corresponding to the questions. The information processing device 10 then presents the acquired questions and a selection of the answers to the questions on the user terminal. The information processing device 10 then receives answers each input for the questions presented on the user terminal (S104) and associates the questions with the answers. The information processing device 10 then uses the questions and answers associated with each other at S104 to refer to the question storage unit 112 and converts the answers into first index values (S106). The information processing device 10 then calculates degree of suitability for each coloration scheme on the basis of the first index value resulting from the conversion (S108). The information processing device 10 then determines whether or not all of the answers received at S104 are processed (S110). When not all of the answers are processed (S110: NO), the information processing device 10 executes the processing from S106 to S108 for the answers that have not been processed. On the other hand, when all of the answers are processed (S110: YES), the information processing device 10 outputs, to the user, the degrees of suitability for each of the coloration schemes calculated at S108 and an optimum coloration scheme based on the degrees of suitability for each of the coloration schemes (S112).

A specific example of the processing flow in the information processing device 10 according to this exemplary embodiment will be described. It is assumed here that the coloration scheme storage unit 132 stores five coloration schemes: red, green, blue, yellow, and brown. First, the information processing device 10 presents questions, to a user, about “sex”, “age”, and “category of industry” and answers to the questions in multiple-choice form. Assume that the user selects “female” as the answer to the question about “sex”, “under 60” as the answer to the question about “age”, and “food” as the answer to the question about “category of industry”. The information processing device 10 uses the question “sex” and the answer “female” to refer to the question storage unit 112 and converts the received answer into a first index value “7”, for the coloration scheme of red. Similarly, the information processing device 10 converts the received answer to the question “age” into a first index value “3”, for the coloration scheme of blue, red, green, and yellow, and converts the received answer to the question “category of industry” into a first index value “10”, for the coloration scheme of yellow.

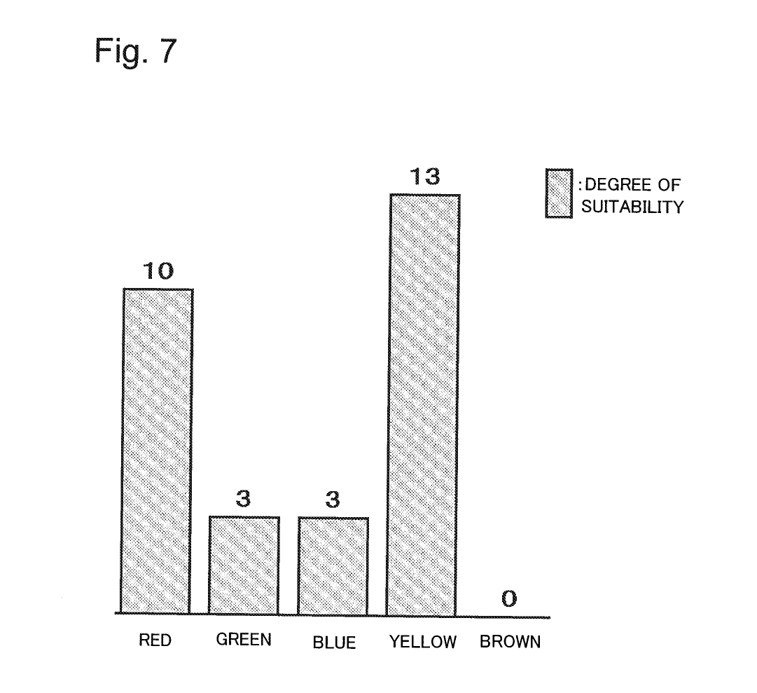

The information processing device 10 then adds together the first index values acquired from the answers to calculate the degree of suitability for each coloration scheme. In this case, the degree of suitability for the coloration scheme of red is “10”, the degree of suitability for the coloration scheme of green is “3”, the degree of suitability for the coloration scheme of blue is “3”, the degree of suitability for the coloration scheme of yellow is “13”, and the degree of suitability for the coloration scheme of brown is “0”. Accordingly, the information processing device 10 determines that the coloration scheme of yellow, which has the highest degree of suitability, is the optimum coloration scheme. The information processing device 10 then outputs the results of the calculated degrees of suitability to the user terminal along with the optimum coloration scheme as illustrated in FIG. 7. FIG. 7 is a diagram illustrating an example of a result output from the information processing device 10 according to the first exemplary embodiment. The information processing device 10 presents the optimum coloration scheme identifiably by using a highlight or a predetermined mark or the like. The information processing device 10 may apply, to a screen, the coloration scheme determined to be optimum and may present the screen by default. This allows the user to readily recognize the optimum coloration scheme. The information to present is not limitative; the information processing device 10 may further display questions and received answers.

As has been described, received answers to presented questions are converted into first index values for each coloration scheme in this exemplary embodiment. The degree of suitability for each coloration scheme is then calculated on the basis of the first index values for each coloration scheme that are acquired by converting each answer. The calculated degree of suitability for each coloration scheme is then presented to the user.

Accordingly, this exemplary embodiment allows the user to readily determine as to how much degree each recommended color scheme suits an object to be colored. The user can then select the coloration scheme that is suitable for the object to be colored.

### Second Exemplary Embodiment

A second exemplary embodiment is similar to the first exemplary embodiment except for the following aspect.

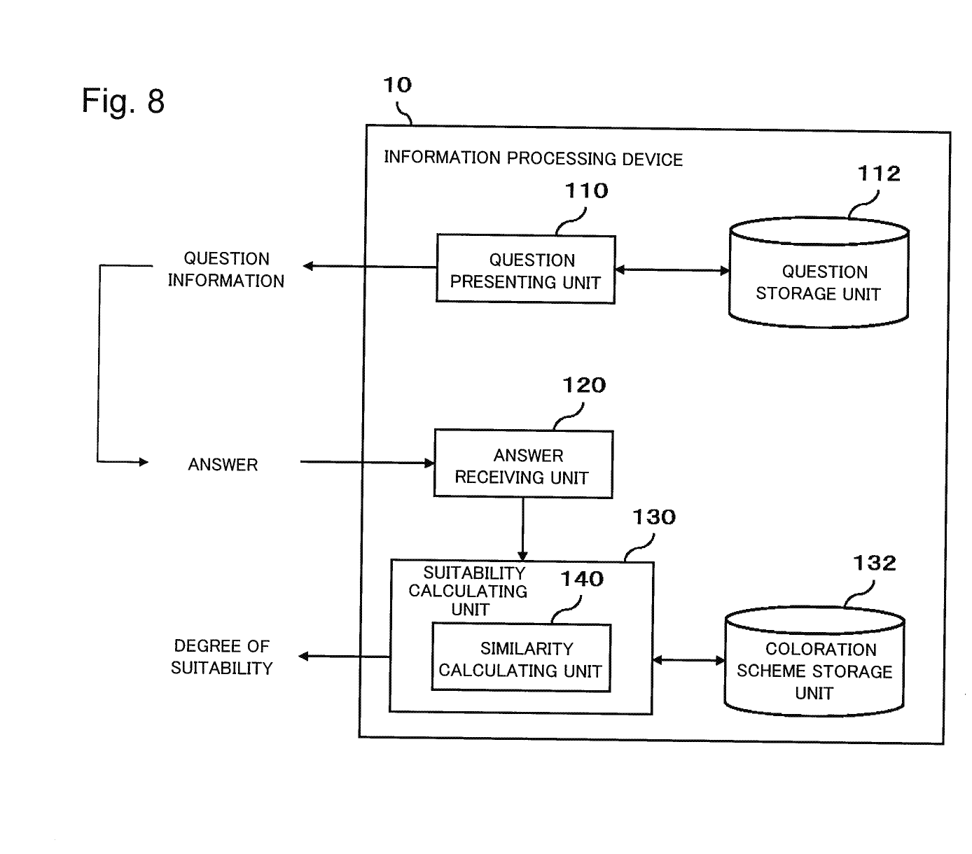

FIG. 8 is a block diagram illustrating an exemplary processing configuration of an information processing device 10 according to the second exemplary embodiment. The information processing device 10 in this exemplary embodiment further includes a similarity calculating unit 140.

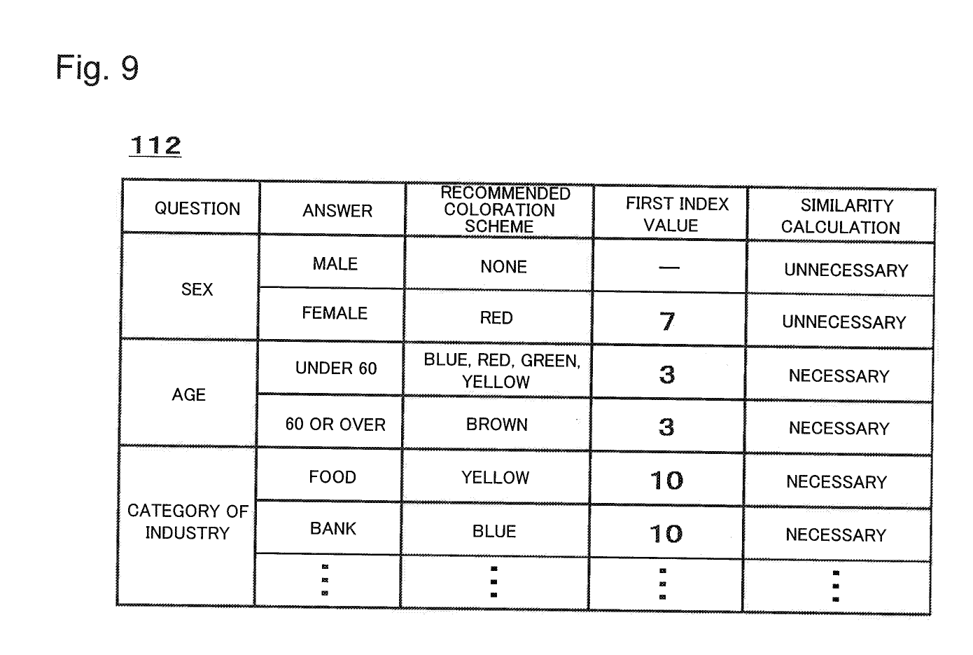

The similarity calculating unit 140 calculates the degree of similarity between the coloration scheme that corresponds to the answer received by the answer receiving unit 120 and the coloration scheme that does not correspond to the answer. In this exemplary embodiment, the similarity calculating unit 140 refers to the question storage unit 112 to determine whether or not the degree of similarity between the coloration scheme that corresponds to an answer received from a user and the coloration scheme that does not correspond to the answer needs to be calculated. When it is determined that the degree of similarity needs to be calculated, the similarity calculating unit 140 executes a process for calculating the degree of similarity. FIG. 9 illustrates an example of information stored in the question storage unit 112 in the second exemplary embodiment. The question storage unit 112 of the second exemplary embodiment stores information concerning “similarity calculation” in addition to the items of information in the first exemplary embodiment. The “similarity calculation” column contains information indicating whether or not calculation of similarity is needed. The similarity calculating unit 140 refers to the information stored in the “similarity calculation” column to determine whether to execute calculation of the degree of similarity. According to FIG. 9, whether or not to execute calculation of the degree of similarity is determined on the basis of questions. However, this method for determining whether or not to execute calculation of the degree of similarity is illustrative only and is not limitative.

A “coloration scheme that corresponds to an answer” herein refers to the coloration scheme that is linked to a given answer as a “recommended coloration scheme” among coloration schemes stored in the coloration scheme storage unit 132. A “coloration scheme that does not correspond to an answer” is the coloration scheme that is not linked to a given answer as a “recommended coloration scheme” among the coloration schemes stored in the coloration scheme storage unit 132. Assume, for example, that the question storage unit 112 stores information illustrated in FIG. 9 and the coloration scheme storage unit 132 stores five coloration schemes; red, green, blue, yellow, and brown. In this case, when an answer to the question about “sex” is “female”, the coloration scheme of red, is a “coloration scheme that corresponds to the answer” and each of coloration schemes of green, blue, yellow, and brown, is “a coloration scheme that does not correspond to the answer”. When an answer to the question about “age” is “under 60”, each of the coloration schemes of red, green, blue, and yellow, is a “coloration scheme that corresponds to the answer” and the brown coloration scheme is a “coloration scheme that does not correspond to the answer”.

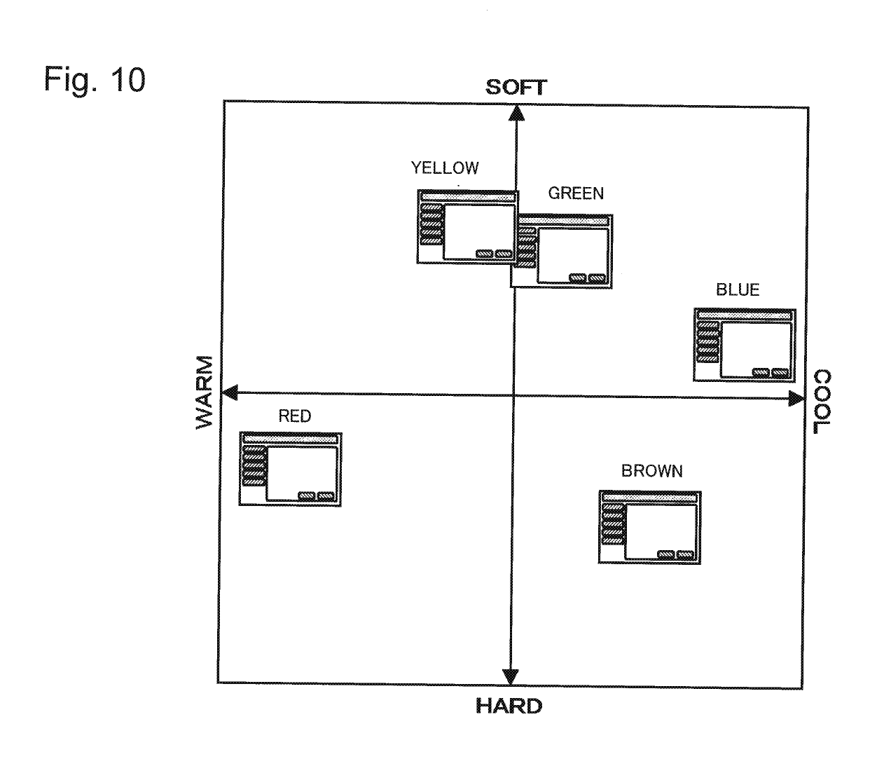

The similarity calculating unit 140 can use a coloration scheme map, for example, to calculate the degree of similarity between the coloration scheme that corresponds to an answer and the coloration scheme that does not correspond to the answer. The coloration scheme map is a map in which coloration schemes are mapped according to human impressions of the coloration schemes (for example, pink is mapped as “cute” and blue is mapped as “refreshing”). Specifically, the coloration scheme map is a map with coloration schemes and impressions of the coloration schemes disposed on a two-dimensional map which has two axes serving as a basis for impressions of coloration schemes. On the coloration scheme map, the closer two coloration schemes to each other in position, the higher the degree of similarity between the impressions of the two coloration schemes; the farther two coloration schemes to each other in position, the lower the degree of similarity between the impressions of the two coloration schemes. FIG. 10 illustrates an example of the coloration scheme map. An example that has two axes, “WARM [symbol] COOL” and “SOFT [symbol] HARD”, is illustrated in the coloration scheme map in FIG. 10.

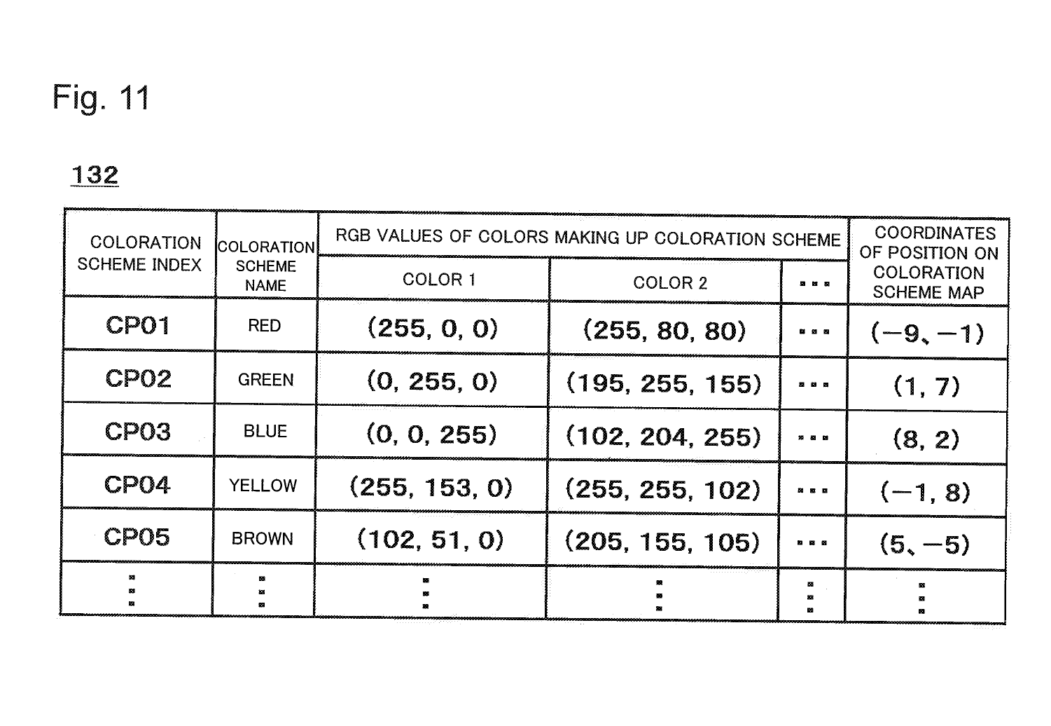

In this exemplary embodiment, the coloration scheme storage unit 132 stores the coordinates of positions on the coloration scheme map for each of the coloration scheme as illustrated in FIG. 11. FIG. 11 is a diagram illustrating an example of information stored in the coloration scheme storage unit 132 in the second exemplary embodiment. The similarity calculating unit 140 uses the “coordinates of positions on the coloration scheme map” to obtain the distance between coloration schemes. Since the distance between coloration schemes indicate the degree of similarity between the impressions of the coloration schemes, the similarity calculating unit 140 treats the distance between the coloration schemes as the degree of similarity between the coloration schemes.

Note that the similarity calculating unit 140 may use other method to calculate the degree of similarity. For example, the similarity calculating unit 140 may use at least one of hue and color tone to calculate the degree of similarity between the coloration scheme that corresponds to the answer and the coloration scheme that does not correspond to the answer. Specifically, the similarity calculating unit 140 may calculate the closeness in hue or color tone between the coloration scheme that corresponds to an answer and the coloration scheme that does not correspond to the answer. The similarity calculating unit 140 may then use the closeness as the degree of similarity. When both of the degrees of similarity calculated on the basis of hue and color tone are used, the similarity calculating unit 140 may adopt the average or the like of the degrees as the degree of similarity. In addition to or instead of this, the degrees of similarity between each coloration scheme may be stored in the coloration scheme storage unit 132 beforehand. Accordingly, the similarity calculating unit 140 may retrieve the degree of similarity between corresponding coloration schemes from the coloration scheme storage unit 132.

In addition to the calculation in the first exemplary embodiment, a suitability calculating unit 130 further converts the degree of similarity calculated by the similarity calculating unit 140 into a first index value for the coloration scheme that does not correspond to an answer. The suitability calculating unit 130 then calculates the degree of suitability of each coloration scheme. In this exemplary embodiment, the suitability calculating unit 130 first determines whether or not the distance between coloration schemes calculated by the similarity calculating unit 140 is less than a predetermined threshold. When the distance between the coloration schemes is less than the predetermined threshold, the suitability calculating unit 130 determines that the degree of similarity between the two coloration schemes is high. The suitability calculating unit 130 then converts the degree of similarity to a predetermined first index value. Note that instead of this, the suitability calculating unit 130 may convert a smaller distance between coloration schemes calculated by the similarity calculating unit 140, i.e., a higher degree of similarity, into a greater first index value. The suitability calculating unit 130 then adds the first index value resulting from the conversion to the degree of suitability for the coloration scheme that does not correspond to the answer.

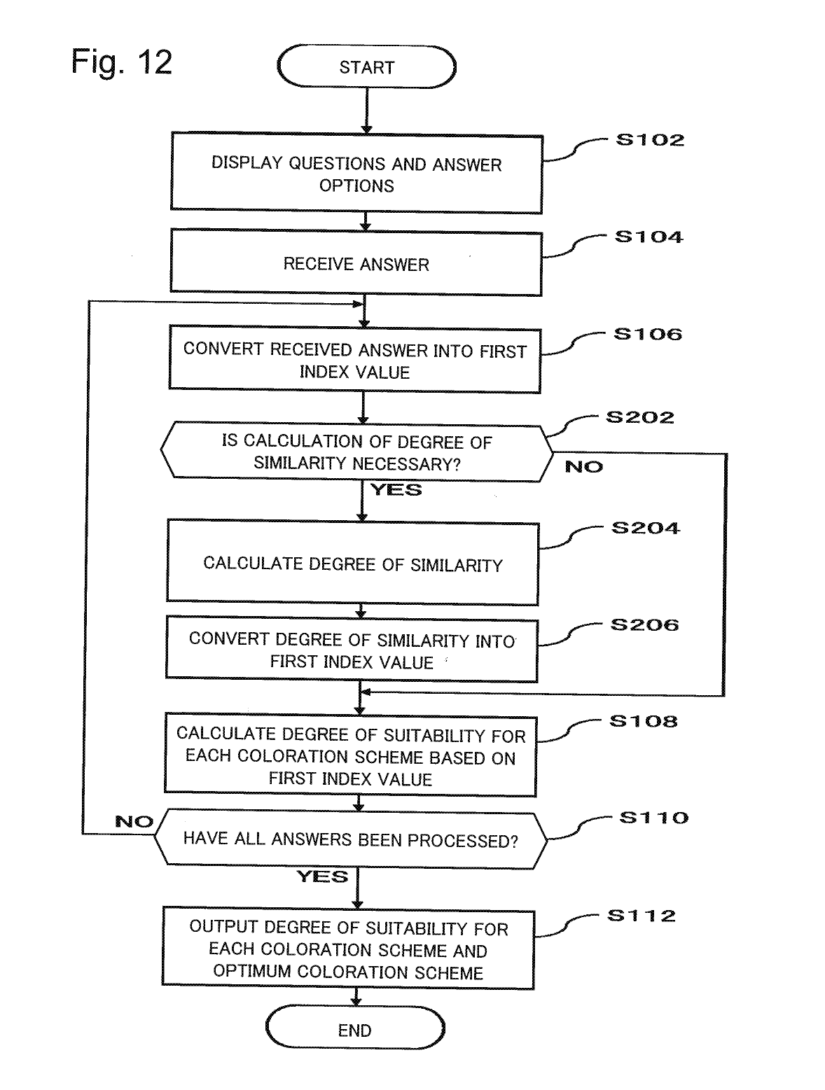

A process flow in the information processing device 10 according to the second exemplary embodiment will be described with reference to FIG. 12. FIG. 12 is a flowchart illustrating a process flow in the information processing device 10 according to the second exemplary embodiment.

The information processing device 10 determines whether or not calculation of the degree of similarity is needed for the received answer (S202). In this exemplary embodiment, the information processing device 10 determines whether or not calculation of the degree of similarity is needed on the basis of information stored in the “similarity calculation” column in the question storage unit 112. When the “similarity calculation” for the received answer is “necessary”, the information processing device 10 determines that calculation of the degree of similarity is needed; when the “similarity calculation” for the received answer is “unnecessary”, the information processing device 10 determines that calculation of the degree of similarity is not needed. When calculation of the degree of similarity is needed (S202: YES), the information processing device 10 calculates the degree of similarity between the coloration scheme that corresponds to the answer and the coloration scheme that does not correspond to the answer (S204). The information processing device 10 then converts the degree of similarity for each coloration scheme that does not correspond to the answer into a first index value (S206). The information processing device 10 then uses the first index values acquired at S106 and S206 to calculate the degree of suitability for each coloration scheme (S108).

A specific example of the process flow in the information processing device 10 according to this exemplary embodiment will be described. It is assumed here that information as illustrated in FIG. 9 is stored in the question storage unit 112. First, the information processing device 10 presents, to a user, questions about “sex”, “age”, and “category of industry” and answers to the questions in multiple-choice form. Assume that the user selects the answers, “female” to the question about “sex”, “under 60” to the question about “age”, and “food” to the question about “category of industry”. In this case, the information processing device 10 converts each answer into a first index value and calculate the degree of suitability for each coloration scheme in accordance with the same flow described in the first exemplary embodiment.

In this exemplary embodiment, the information processing device 10 refers to the “similarity calculation” column in the question storage unit 112 to determine whether or not a process for calculating the degree of similarity is needed. Description will be continued here by taking the question about the “category of industry” as an example. Information in the question storage unit 112 illustrated in FIG. 9 indicates that the degree of similarity needs to be calculated. Accordingly, the information processing device 10 refers to the coloration scheme storage unit 132 and acquires the coordinates of the position of each coloration scheme on the coloration scheme map. The information processing device 10 then calculates the distance between a coloration scheme of yellow, which corresponds to the answer, and each of coloration schemes of red, green blue, and brown, which do not correspond to the answer. The results of the calculations are: the distance between the coloration scheme of yellow and the coloration scheme of red is “12.0”, the distance between the coloration scheme of yellow and the coloration scheme of green is “2.2”, the distance between the coloration scheme of yellow and the coloration scheme of blue is “10.8”, and the distance between the coloration scheme of yellow and the coloration scheme of brown is “14.3”. The information processing device 10 then searches for a combination of coloration schemes with the distance therebetween is less than a threshold (3, in this example). In this case, the distance between the coloration scheme of yellow and the coloration scheme of green is less than the threshold. Therefore, the information processing device 10 adds a predetermined first index value to the degree of suitability for the coloration scheme of green. Since the first index value of the coloration scheme of yellow which corresponds to the answer is “10”, one half of the value, namely “5”, for example, is added as the first index value to acquire the degree of suitability for the coloration scheme of green.

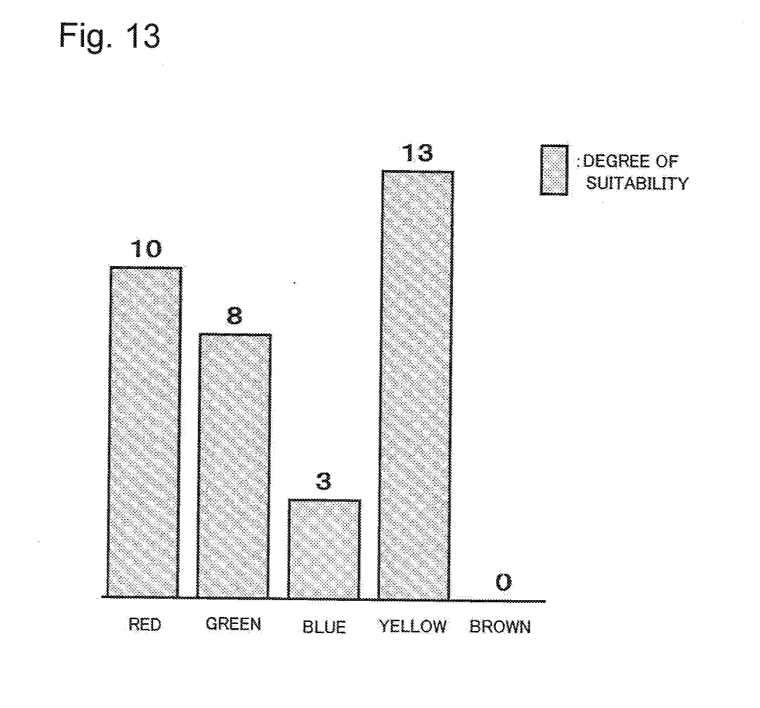

When the process described above is performed similarly for the questions about “sex” and “age”, the degree of suitability for the coloration scheme of red is “10”, the degree of suitability for the coloration scheme of green is “8”, the degree of suitability for the coloration scheme of blue is “3”, the degree of suitability for the coloration scheme of yellow is “13”, and the degree of suitability for the coloration scheme of brown is “0”. The information processing device 10 outputs the results of the calculated degrees of suitability to the user terminal along with the optimum coloration scheme as in the first exemplary embodiment. FIG. 13 illustrates an example of a result output from the information processing device 10 in the second exemplary embodiment.

As described above, since the degrees of similarity between coloration schemes are taken into account in this exemplary embodiment, the degree of suitability for each coloration scheme is calculated more precisely. This allows the user to select the coloration scheme that is suitable for an object to be colored more precisely.

### Third Exemplary Embodiment

A third exemplary embodiment is similar to the first and second exemplary embodiments except for the following aspect.

An information processing device 10 according to this exemplary embodiment includes processing components similar to those in FIG. 1. In this exemplary embodiment, a suitability calculating unit 130 further converts the answer received by the answer receiving unit 120 into a second index value. A “second index value” herein is a value indicating the degree of unsuitability for the coloration scheme that is determined to be unsuitable to a given answer. The suitability calculating unit 130 of this exemplary embodiment uses a first index value and a second index value to calculate the degree of suitability for each coloration scheme.

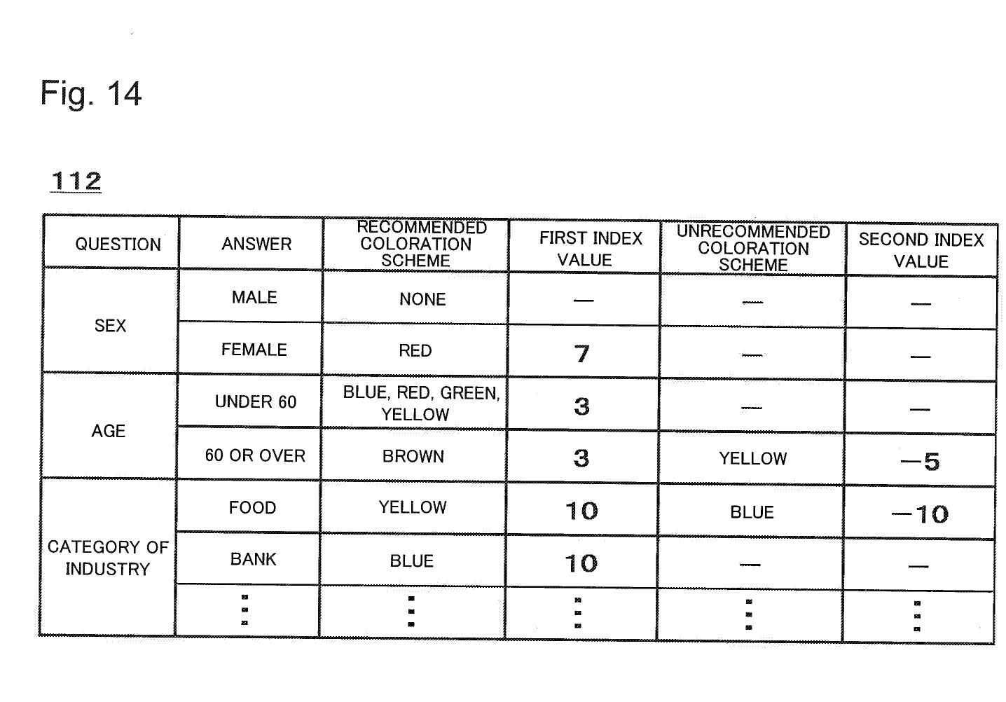

FIG. 14 illustrates an example of information stored in a question storage unit 112 in this exemplary embodiment. As illustrated in FIG. 14, the question storage unit 112 of this exemplary embodiment further stores “unrecommended coloration schemes” and “second index values” in addition to information in the first exemplary embodiment. The “recommended coloration scheme” column stores information indicating coloration schemes that are unsuitable for answers. The “second index value” column stores information indicating the degrees of unsuitability for each coloration scheme stored in the “unrecommended coloration scheme”.

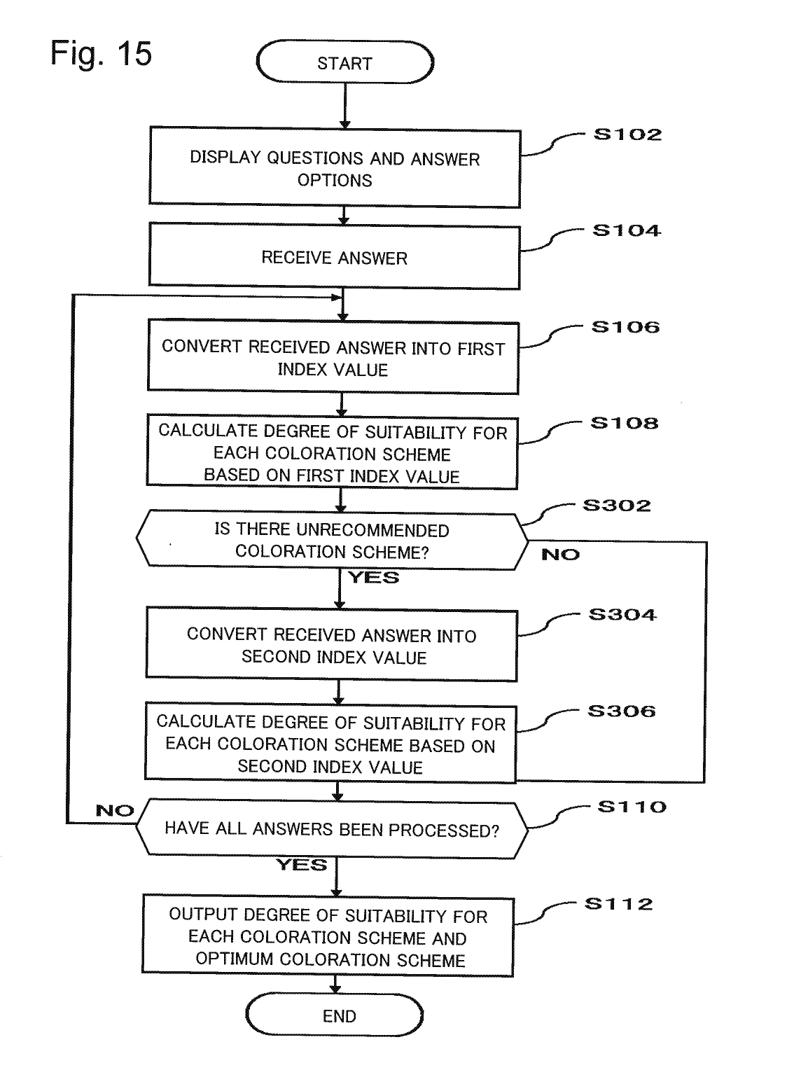

A process flow in the information processing device 10 according to the third exemplary embodiment will be described with reference to FIG. 15. FIG. 15 is a flowchart illustrating a process flow in the information processing device 10 according to the third exemplary embodiment.

The information processing device 10 refers to the question storage unit 112 to determine whether or not there is an unrecommended coloration scheme that corresponds to the received answer (S302). When there is an unrecommended coloration scheme (S302: YES), the information processing device 10 refers to the question storage unit 112 and converts the received answer into a second index value (S304). The information processing device 10 then calculates the degree of suitability for each coloration scheme on the basis of the second index value (S306). On the other hand, when there is no unrecommended coloration scheme (S302: NO), the information processing device 10 does not execute the processing from S304 to S306.

A specific example of the process flow in the information processing device 10 according to this exemplary embodiment will be described. It is assumed here that the question storage unit 112 stores information as illustrated in FIG. 14. First, the information processing device 10 presents, to a user, questions about “sex”, “age”, and “category of industry” and answers to each of the questions in multiple-choice form. Assume that the user selects the answers, “female” to the question about “sex”, “under 60” to the question about “age”, and “food” to the question about “category of industry”. In this case, the information processing device 10 converts each answer into a first index value and calculate the degree of suitability for each coloration scheme in accordance with the same flow described in the first exemplary embodiment. A coloration scheme of blue is linked to the answer “food” as an unrecommended coloration scheme. Accordingly, the information processing device 10 refers to the question storage unit 112 and converts the answer to the question about “category of industry” into “−10” that is a second index value of the coloration scheme of blue.

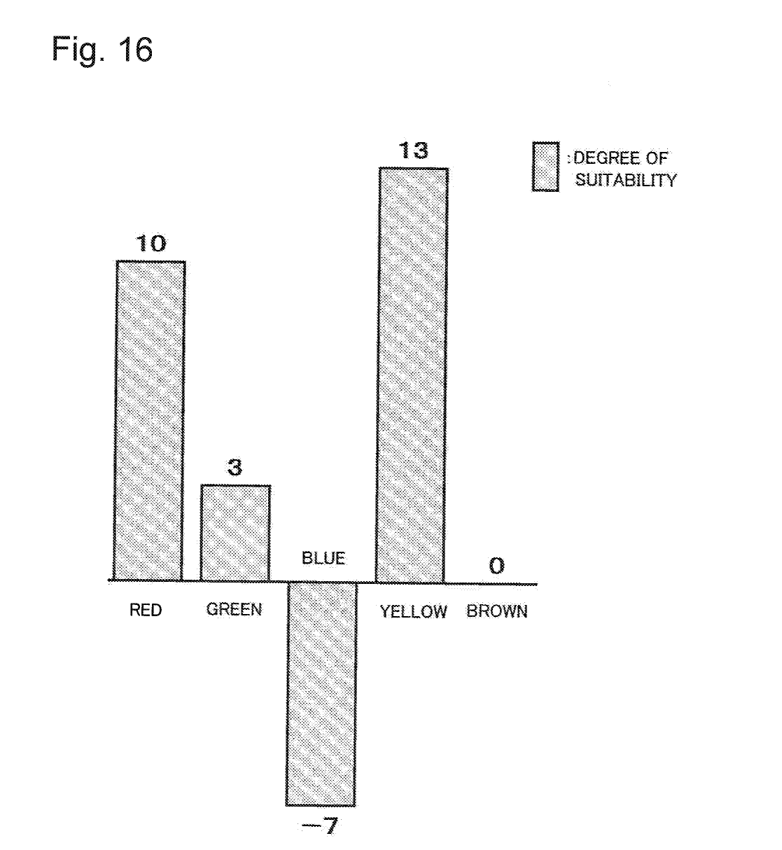

The information processing device 10 then calculates the degree of suitability for each coloration scheme by taking the second index value from each answer into account. In this case, the degree of suitability for the coloration scheme of red is “10”, the degree of suitability for the coloration scheme of green is “3”, the degree of suitability for the coloration scheme of blue is “−7”, the degree of suitability for the coloration scheme of yellow is “13”, and the degree of suitability for the coloration scheme of brown is “0”. The information processing device 10 then outputs, to the user terminal, the results of the calculated degrees of suitability along with the optimum coloration scheme as in the first exemplary embodiment. FIG. 16 illustrates an example of a result output from the information processing device 10.

As described above, in this exemplary embodiment, the answer received by the information processing device 10 is further converted into a second index value which indicates the degree of unsuitability for each coloration scheme to the answer. The second index value resulting from the conversion is further used for calculating the degree of suitability for each coloration scheme.

In this way, according to this exemplary embodiment, the degree of suitability for each coloration scheme is calculated by considering coloration schemes that are unsuitable for an impression (unrecommended color schemes). Therefore, a user can more precisely determine the coloration scheme suitable for an object to be colored.

### Fourth Exemplary Embodiment

A fourth exemplary embodiment is similar to the first to third exemplary embodiments except for the following aspect.

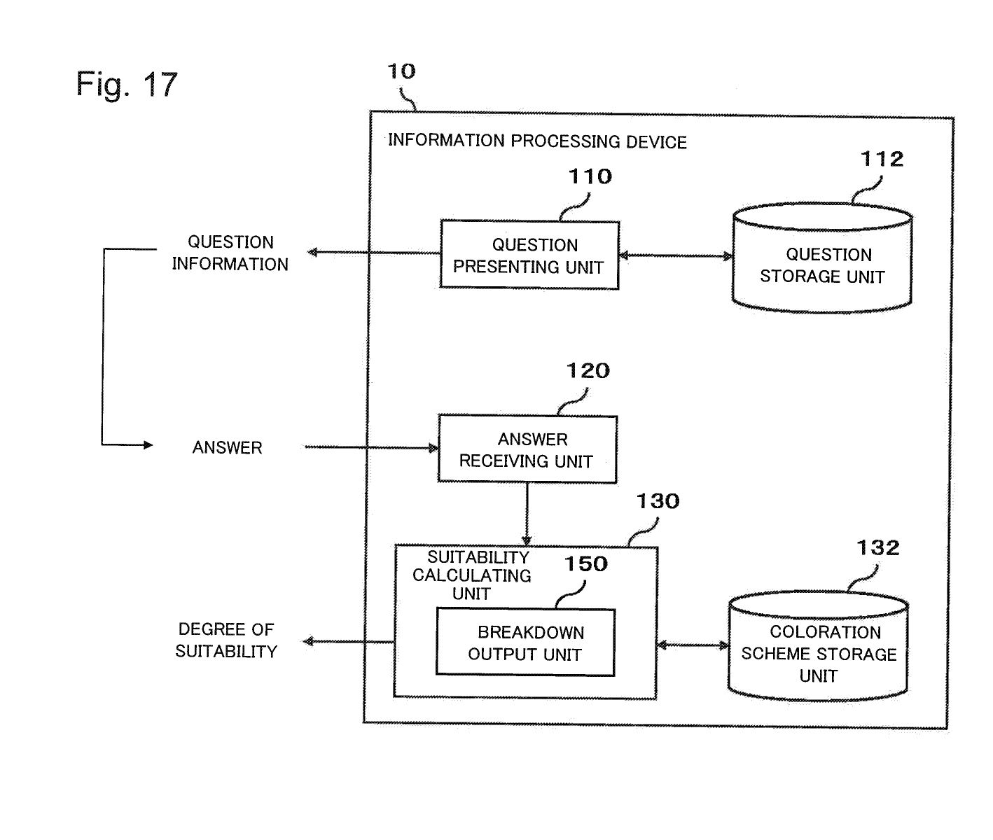

FIG. 17 is a block diagram illustrating an exemplary processing configuration of an information processing device 10 according to the fourth exemplary embodiment. In this exemplary embodiment, the information processing device 10 further includes a breakdown output unit 150.

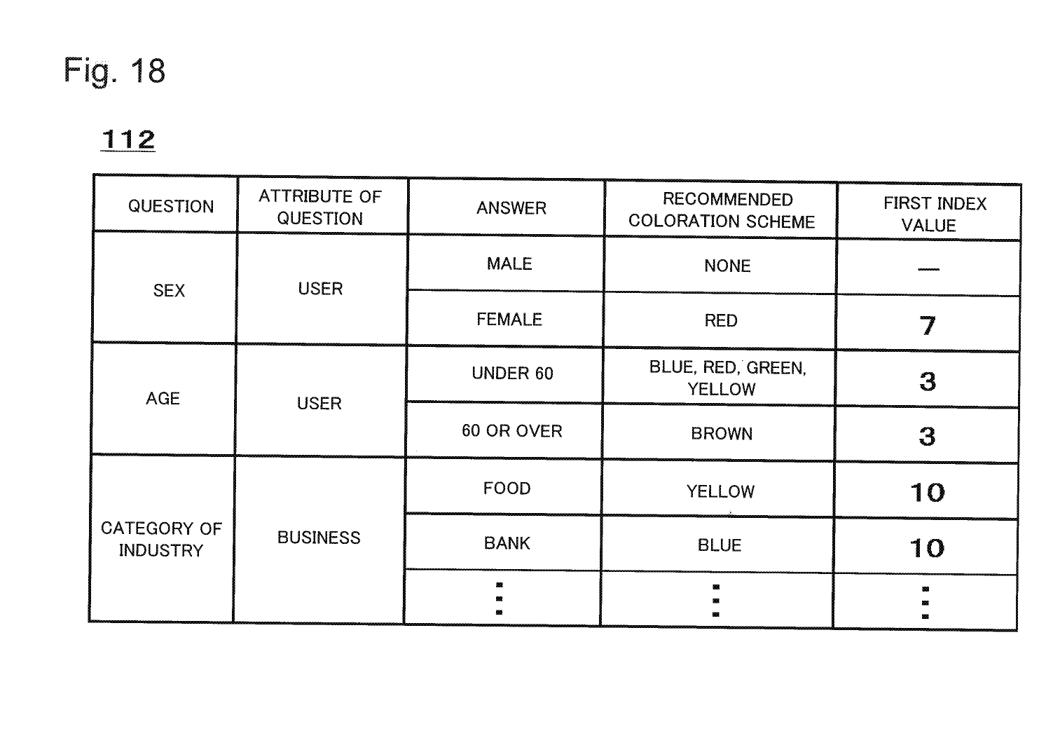

At least one of a plurality of available attributes is assigned to question information in this exemplary embodiment. The breakdown output unit 150 outputs a breakdown of each attribute in the degree of suitability for each coloration scheme on the basis of the attribute assigned to question information. FIG. 18 illustrates an example of information stored in a question storage unit 112 in this exemplary embodiment. As illustrated in FIG. 18, the question storage unit 112 of this exemplary embodiment further stores “attribute of question” in addition to the information in the first exemplary information. In this exemplary embodiment, the breakdown output unit 150 uses the “attribute of question” to distinguish whether a first index value acquired from the received answer is being as the “degree of suitability for a user property” or as the “degree of suitability for a business property”. Specifically, when the “attribute of question” is “user”, the breakdown output unit 150 determines that a first index value acquired from the received answer is the “degree of suitability to user property”; when the “attribute of answer” is “business”, the breakdown output unit 150 determines that a first index value acquired from the received answer is the “degree of suitability to business property”. While questions are classified into two types of “attributes of questions”, that is, “user” and “business”, in the example given in FIG. 18 for convenience of explanation, the “attributes of questions” are not limitative. Questions may be classified according to attributes other than “user” and “business”, depending on content of the questions. Further, questions may be given two or more attributes depending on the content of the questions.

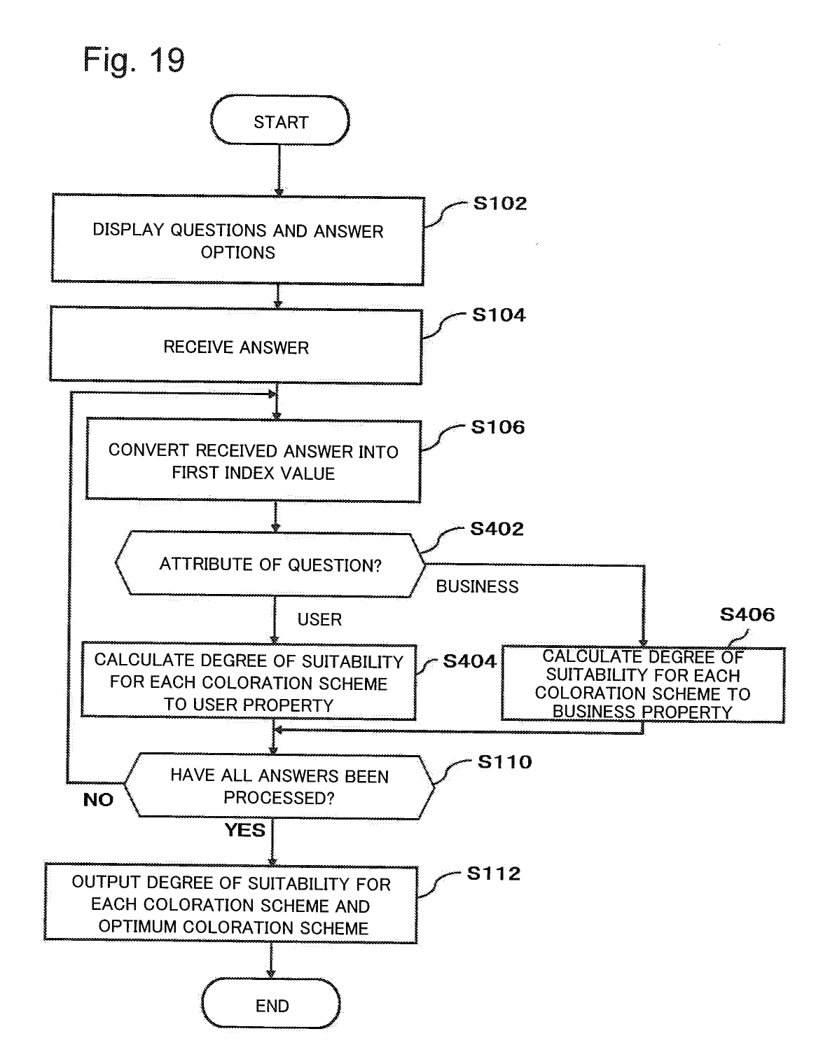

A process flow in the information processing device 10 according to the fourth exemplary embodiment will be described with reference to FIG. 19. FIG. 19 is a flowchart illustrating a process flow in the information processing device 10 according to the fourth exemplary embodiment.

The information processing device 10 determines an attribute of a question corresponding to the received answer (S402). When the attribute of the question is “user” (S402: USER), the information processing device 10 uses a first index value resulting from conversion at S106 as the degree of suitability for the user property to calculate the degree of suitability for each coloration scheme (S404). On the other hand, when the attribute of the question is “business” (S402: BUSINESS), the information processing device 10 uses the first index value resulting from conversion at S106 as the degree of suitability for the business property to calculate the degree of suitability for each coloration scheme (S406).

A specific example of the process flow in the information processing device 10 according to this exemplary embodiment will be described. It is assumed here that the question storage unit 112 stores information as illustrated in FIG. 18. First, the information processing device 10 presents, to a user, questions about “sex”, “age”, and “category of industry” and answers to the questions in multiple-choice form. Assume that the user selects answers, “female” to the question about “sex”, “under 60” to the question about “age”, and an “food” to the question about “category of industry”. In this case, the information processing device 10 refers to the question storage unit 112 and converts the answer to the question about “sex” into “7” that is a first index value of the coloration scheme of red. Here, since the attribute of the question corresponding to “sex” is “user”, the information processing device 10 sets, for example, a flag indicating the degree of suitability for the user property to calculate “7” that is the first index value for the coloration scheme of red as the “degree of suitability to the user property”. Similarly, the information processing device 10 sets a first index value acquired from the answer to the question about “age” as the “degree of suitability to the user property” and sets a first index value acquired from the question about “category of industry” as the “degree of suitability for the business property”.

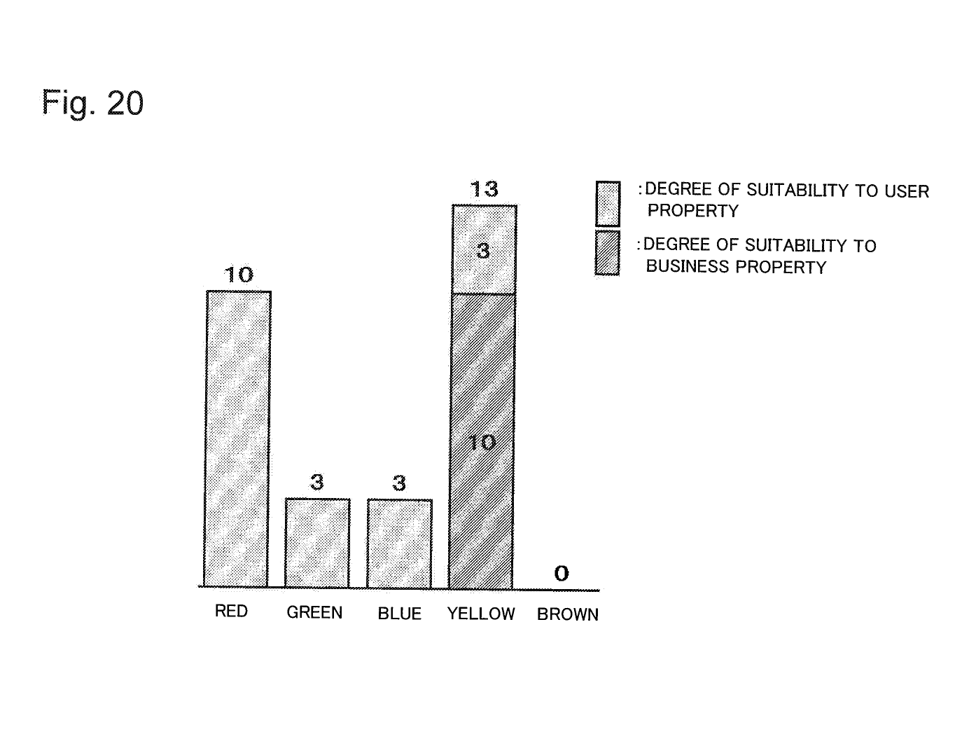

The information processing device 10 then adds the first index values acquired from each of the answers together to calculate the degree of suitability for each coloration scheme. In this case, regarding the degree of suitability for the coloration scheme of red, the degree of suitability to the user property is “10”, the degree of suitability to the business property is “0”, and therefore the total is “10”. Regarding the coloration schemes of green and blue, the degree of suitability to the user property is “3”, the degree of suitability to the business property is “0”, and therefore the total is “3”. Regarding the degree of suitability for the coloration scheme of yellow, the degree of suitability to the user property is “3”, the degree of suitability to the business property is “10”, and therefore the total is “13”. Regarding the degree of suitability for the coloration scheme of brown, both of the user property and business property is “0”, and therefore the total is “0”. Based on this result, the information processing device 10 outputs information as illustrated in FIG. 20 to the user terminal. FIG. 20 is a diagram illustrating an example of a result output from the information processing device 10 according to the fourth exemplary embodiment.

As described above, in this embodiment, the breakdown of the degrees of suitability in regard to properties of a system such as user property and business property are output for each coloration schemes in accordance with attributes assigned to question information presented. Accordingly, this exemplary embodiment allows a user to select the coloration scheme that is more suitable for the user by considering output information and properties of a system to which the coloration scheme is to be applied.

While exemplary embodiments of the present invention have been described with reference to the drawings, the exemplary embodiments are illustrative of the invention and various other configurations other than the above may be adopted.

For example, the degree of suitability for each coloration scheme is calculated by addition in the exemplary embodiments described above. However, the addition is illustrative only and not limitative. Each coloration scheme may have a predetermined default degree of suitability. Further, the degree of suitability for each coloration scheme may be calculated by subtracting the degree of suitability for the coloration scheme that is unsuitable for the received answer.

In the foregoing description, a plurality of steps (processing steps) in each of the flowcharts are illustrated in order. However, the order in which the steps are executed in each exemplary embodiment are not limitative. The order of the steps illustrated in each exemplary embodiment may be altered without compromising the functionality. Further, any of the exemplary embodiments can be combined as long as there is no contradiction.

Examples of reference embodiments will be appended below.
1. An information processing device comprising:

question presenting means for acquiring at least one piece of question information from question storage means in which pieces of the question information are stored and presenting the piece of question information;

answer receiving means for receiving an answer to the presented question information; and

suitability calculating means for converting the received answer into a first index value which indicates a degree of suitability of a coloration scheme to the answer and calculating a degree of suitability of each of a plurality of prepared coloration schemes on the basis of the first index value.
2. The information processing device according to 1.,

wherein the answer and the coloration schemes are associated with each other beforehand, and the information processing device further comprises similarity calculating means for calculating a degree of similarity between the coloration scheme that corresponds to the answer out of the plurality of coloration schemes and the coloration schemes that does not correspond to the answer out of the plurality of coloration schemes, and

the suitability calculating means further converts the degree of similarity into the first index value of the coloration scheme that does not correspond to the answer and calculates a degree of suitability of each of the coloration schemes.
3. The information processing device according to 2, wherein the similarity calculating means calculates the degree of similarity using at least one of hue and color tone.
4. The information processing device according to any one of 1. to 3., wherein the suitability calculating means further converts the received answer into a second index value indicating a degree of unsuitability of each of the plurality of prepared coloration schemes for the answer and calculates the degree of suitability of each of the coloration schemes using the second index value.
5. The information processing device according to any one of 1. to 4.,

wherein at least one of a plurality of attributes is assigned to the question information, and the information processing device further comprises breakdown outputting means for outputting a breakdown of each of the attributes in the degree of suitability of each of the coloration schemes on the basis of the attribute assigned to the question information.
6. The information processing device according to any one of 1. to 5., wherein the question presenting means presents the answers prepared for each of the question information in a multiple-choice form.
7. An information processing method performed by a computer, the method comprising:

acquiring at least one piece of question information from question storage means in which pieces of the question information are stored and presenting the piece of question information;

receiving an answer to the presented question information; and

converting the received answer into a first index value which indicates a degree of suitability of a coloration scheme to the answer and calculating a degree of suitability of each of a plurality of prepared coloration schemes on the basis of the first index value.
8. The information processing method according to 7.,

wherein the answer and the coloration schemes are associated with each other beforehand, and the information processing device further comprises similarity calculating means for calculating a degree of similarity between the coloration scheme that corresponds to the answer out of the plurality of coloration schemes and the coloration schemes that does not correspond to the answer out of the plurality of coloration schemes, and

the suitability calculating means further converts the degree of similarity into the first index value of the coloration scheme that does not correspond to the answer and calculates a degree of suitability of each of the coloration schemes.
9. The information processing method according to 8., wherein the similarity calculating means calculates the degree of similarity using at least one of hue and color tone.
10 The information processing method according to any one of 7. to 9., wherein the suitability calculating means further converts the received answer into a second index value indicating a degree of unsuitability of each of the plurality of prepared coloration schemes for the answer and calculates the degree of suitability of each of the coloration schemes using the second index value.
11. The information processing method according to any one of 7. to 10.,

wherein at least one of a plurality of attributes is assigned to the question information, and

the information processing device further comprises breakdown outputting means for outputting a breakdown of each of the attributes in the degree of suitability of each of the coloration schemes on the basis of the attribute assigned to the question information.
12. The information processing method according to any one of 7. to 11., wherein the question presenting means presents the answers prepared for each of the question information in a multiple-choice form.
13. A program for causing a computer to function as:

question presenting means for acquiring at least one piece of question information from question storage means in which pieces of the question information are stored and presenting the piece of question information;

answer receiving means for receiving an answer to the presented question information; and

suitability calculating means for converting the received answer into a first index value which indicates a degree of suitability of a coloration scheme to the answer and calculating a degree of suitability of each of a plurality of prepared coloration schemes on the basis of the first index value.
14. The program according to 13.,

wherein the answer and the coloration schemes are associated with each other beforehand, and the information processing device further comprises similarity calculating means for calculating a degree of similarity between the coloration scheme that corresponds to the answer out of the plurality of coloration schemes and the coloration schemes that does not correspond to the answer out of the plurality of coloration schemes, and

the suitability calculating means further converts the degree of similarity into the first index value of the coloration scheme that does not correspond to the answer and calculates a degree of suitability of each of the coloration schemes.
15. The program according to 14., wherein the similarity calculating means calculates the degree of similarity using at least one of hue and color tone.
16. The program according to any one of 13. to 15., wherein the suitability calculating means further converts the received answer into a second index value indicating a degree of unsuitability of each of the plurality of prepared coloration schemes for the answer and calculates the degree of suitability of each of the coloration schemes using the second index value.
17. The program according to any one of 13. to 16.,

wherein at least one of a plurality of attributes is assigned to the question information, and

the information processing device further comprises breakdown outputting means for outputting a breakdown of each of the attributes in the degree of suitability of each of the coloration schemes on the basis of the attribute assigned to the question information.
18. The program according to any one of 13. to 17., wherein the question presenting means presents the answers prepared for each of the question information in a multiple-choice form.

This application is based upon and claims the benefit of priority from Japanese Patent Application No. 2013-123317 filed on Jun. 12, 2013, the entire disclosure of which is incorporated herein.

What is claimed is:

1. An information processing device comprising circuitry configured to:
acquire at least one piece of question information from question storage means in which pieces of the question information are stored and present the piece of question information;
receive an answer to the presented question information; and
convert the received answer into a first index value which indicates a degree of suitability of a coloration scheme to the answer and calculating a degree of suitability of each of a plurality of prepared coloration schemes on the basis of the first index value.

2. The information processing device according to claim 1,
wherein the answer and the coloration schemes are associated with each other beforehand, and the circuitry is further configured to calculate a degree of similarity between the coloration scheme that corresponds to the answer out of the plurality of coloration schemes and the coloration schemes that does not correspond to the answer out of the plurality of coloration schemes, and
the circuitry is further configured to convert the degree of similarity into the first index value of the coloration scheme that does not correspond to the answer and calculates a degree of suitability of each of the coloration schemes.

3. The information processing device according to claim 2, wherein the circuitry is further configured to calculate the degree of similarity using at least one of hue and color tone.

4. The information processing device according to claim 1 wherein the circuitry is further configured to convert the received answer into a second index value indicating a degree of unsuitability of each of the plurality of prepared coloration schemes for the answer and calculate the degree of suitability of each of the coloration schemes further using the second index value.

5. The information processing device according to claim 1,
wherein at least one of a plurality of attributes is assigned to the question information, and
the information processing device further comprises the circuitry configured to outputs a breakdown of each of the attributes in the degree of suitability of each of the coloration schemes on the basis of the attribute assigned to the question information.

6. The information processing device according to claim 1, wherein the circuitry is further configured to present the answers prepared for each of the question information in a multiple-choice form.

7. An information processing method performed by a computer, the method comprising:
acquiring at least one piece of question information from question storage means in which pieces of the question information are stored and presenting the piece of question information;
receiving an answer to the presented question information; and
converting the received answer into a first index value which indicates a degree of suitability of a coloration scheme to the answer and calculating a degree of suitability of each of a plurality of prepared coloration schemes on the basis of the first index value.

8. A non-transitory computer-readable storage medium storing a program for causing a computer to function as:
question presenting means for acquiring at least one piece of question information from question storage means in which pieces of the question information are stored and presenting the piece of question information;
answer receiving means for receiving an answer to the presented question information; and
suitability calculating means for converting the received answer into a first index value which indicates a degree of suitability of a coloration scheme to the answer and calculating a degree of suitability of each of a plurality of prepared coloration schemes on the basis of the first index value.

9. The information processing device according to claim 2, wherein the circuitry is further configured to convert the received answer into a second index value indicating a degree of unsuitability of each of the plurality of prepared coloration schemes for the answer and calculate the degree of suitability of each of the coloration schemes further using the second index value.

10. The information processing device according to claim 3, wherein the circuitry is further configured to convert the received answer into a second index value indicating a degree of unsuitability of each of the plurality of prepared coloration schemes for the answer and calculate the degree of suitability of each of the coloration schemes further using the second index value.

11. The information processing device according to claim 2,
wherein at least one of a plurality of attributes is assigned to the question information, and
the information processing device further comprises the circuitry configured to outputs a breakdown of each of the attributes in the degree of suitability of each of the coloration schemes on the basis of the attribute assigned to the question information.

12. The information processing device according to claim 3,
wherein at least one of a plurality of attributes is assigned to the question information, and
the information processing device further comprises the circuitry configured to outputs a breakdown of each of the attributes in the degree of suitability of each of the coloration schemes on the basis of the attribute assigned to the question information.

13. The information processing device according to claim 4,
wherein at least one of a plurality of attributes is assigned to the question information, and
the information processing device further comprises the circuitry configured to outputs a breakdown of each of the attributes in the degree of suitability of each of the coloration schemes on the basis of the attribute assigned to the question information.

14. The information processing device according to claim 2, wherein of the question information in a multiple-choice form.

15. The information processing device according to claim 3, wherein the circuitry is further configured to present the answers prepared for each of the question information in a multiple-choice form.

16. The information processing device according to claim 4, wherein the circuitry is further configured to present the answers prepared for each of the question information in a multiple-choice form.

17. The information processing device according to claim 5, wherein the circuitry is further configured to present the answers prepared for each of the question information in a multiple-choice form.
